(19) United States
(12) Patent Application Publication
(10) Pub. No.: US 2024/0020624 A1
(43) Pub. Date: Jan. 18, 2024

(54) NFTS FOR PROOF OF OWNERSHIP/DELIVERY OF SHIPPING CONTAINERS AND CARGO

(71) Applicant: STATE FARM MUTUAL AUTOMOBILE INSURANCE COMPANY, Bloomington, IL (US)

(72) Inventors: Aaron Williams, Congerville, IL (US); Joseph Robert Brannan, Bloomington, IL (US); John Donovan, Bloomington, IL (US); Brian N. Harvey, Bloomington, IL (US)

(21) Appl. No.: 17/900,684

(22) Filed: Aug. 31, 2022

Related U.S. Application Data
(60) Provisional application No. 63/388,467, filed on Jul. 12, 2022.

(51) Int. Cl. G06Q 10/08; H04L 9/32; H04L 9/00

(52) U.S. Cl. CPC G06Q 10/0833; H04L 9/3213; H04L 9/50

(57) ABSTRACT

The present systems and method relate generally to using non-fungible tokens (NFTs) to track shipping items. In some embodiments, identification information of a shipping item is obtained. An NFT may then be minted representing ownership of the shipping item. An indication that a receiving party has received the shipping item may then trigger transfer of the NFT to the receiving party to indicate that the receiving party possesses the shipping item.

### CROSS REFERENCE TO RELATED APPLICATIONS

This application claims the benefit of U.S. Provisional Patent Application No. 63/388,467, entitled “NFTs for Proof of Ownership/Delivery of Shipping Containers and Cargo,” filed Jul. 12, 2022, which is hereby expressly incorporated by reference herein in its entirety.

### FIELD

The present disclosure generally relates to tracking shipping items. More particularly, the present disclosure relates to using non-fungible tokens (NFTs) to track shipping items.

### BACKGROUND

Current systems for tracking shipping items may have certain drawbacks. For instance, certain systems may track a shipping item, but may not provide a description of the shipping item. In another example, certain tracking systems are not robust because a single failure may cause the entire system to collapse. In yet another example, certain tracking systems are unable to distinguish between ownership and possession of the shipping item.

The systems and methods disclosed herein provide solutions to these problems and may provide solutions to other inefficiencies, issues, or drawbacks of conventional techniques.

### SUMMARY

The present embodiments relate to, inter alia, using non-fungible tokens (NFTs) to track shipping items. In certain embodiments, an NFT may be minted (or otherwise created or generated) to represent ownership of a trailer, shipping container, cargo box, cargo, etc. The NFT may be transferred amongst users when the physical trailer, shipping container, cargo, etc. is transferred to prove receipt and ownership of the trailer, shipping container, cargo, etc. The NFT may also be used for inventory tracking to track the individual items in the trailer or shipping container, or be a combined NFT detailing the total value of the load or cargo items.

Furthermore, there may be a service to verify that the title holder of the physical item matches the NFT owner—such as use of two-factor authentication for both the seller and buyer when a sale or transfer of the shipping container or cargo items is about to happen to ensure that the NFT reflects true ownership and to prevent fraud.

In one aspect, a computer-implemented method for using non-fungible tokens (NFTs) to track shipping items may be provided. The method may be implemented via one or more local or remote processors, servers, sensors, transceivers, virtual reality headsets, memory units, and/or other electronic or electrical components. In one instance, the method may include: (1) obtaining, via one or more processors, identification information of a shipping item; (2) minting, via the one or more processors, an NFT on a distributed ledger, the NFT representing ownership of the shipping item and including the identification information of the shipping item; (3) receiving, via the one or more processors, an indication that a receiving party has received the shipping item; and/or (4) in response to receiving the indication that the receiving party has received the shipping item, transferring, via the one or more processors, the NFT to the receiving party to indicate that the receiving party possesses the shipping item. The method may include additional, fewer, or alternate actions, including those discussed elsewhere herein.

In another aspect, a computer system for using non-fungible tokens (NFTs) to track shipping items may be provided. The computer system may include one or more local or remote processors, transceivers, servers, sensors, memory units, virtual reality headsets, and/or other electronic or electrical components configured to: (1) obtain identification information of a shipping item; (2) mint an NFT on a distributed ledger, the NFT representing ownership of the shipping item and including the identification information of the shipping item; (3) receive an indication that a receiving party has received the shipping item; and/or (4) in response to receiving the indication that the receiving party has received the shipping item, transfer, via the one or more processors, the NFT to the receiving party to indicate that the receiving party possesses the shipping item. The computer system may include additional, less, or alternate functionality, including that discussed elsewhere herein.

In yet another aspect, a computer device for using non-fungible tokens (NFTs) to track shipping items may be provided. The computer device may include: one or more processors and transceivers; and one or more memories coupled to the one or more processors. The one or more memories including computer executable instructions stored therein that, when executed by the one or more processors, may cause the one or more processors to: (1) obtain identification information of a shipping item; (2) mint an NFT on a distributed ledger, the NFT representing ownership of the shipping item and including the identification information of the shipping item; (3) receive an indication that a receiving party has received the shipping item; and/or (4) in response to receiving the indication that the receiving party has received the shipping item, transfer, via the one or more processors, the NFT to the receiving party to indicate that the receiving party possesses the shipping item. The computer device may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 illustrates an exemplary computer system for using NFTs to track shipping items.

FIG. 2 shows an exemplary scenario where the transferring party comprises a person, and the receiving party comprises a truck.

FIG. 3 shows an exemplary scenario where the transferring party comprises a truck, and the receiving party comprises a warehouse.

FIG. 4 illustrates exemplary network nodes and an exemplary distributed ledger.

FIG. 5 illustrates exemplary network nodes, and an exemplary transaction flow on a distributed ledger network.

FIG. 6 illustrates exemplary components of a network node on a distributed ledger network.

FIG. 7 illustrates an example blockchain having blocks of transactions.

FIG. 8 depicts an exemplary transaction in a distributed ledger network for tracking shipping items using NFTs.

FIG. 9 depicts an exemplary smart contract state in a distributed ledger network for tracking shipping items using NFTs.

FIG. 10 shows an exemplary flow diagram of an exemplary computer-implemented method for tracking shipping items using NFTs.

While the systems and methods disclosed herein is susceptible of being embodied in many different forms, it is shown in the drawings and will be described herein in detail specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein is not limited in its application to the details of construction and to the arrangements of components set forth above and below, illustrated in the drawings, or as described in the examples. Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

A blockchain (also referred to herein as a distributed ledger) is a way of achieving a distributed consensus on the validity or invalidity of information in the chain. In other words, the blockchain provides a decentralized trust to participants and observers. As opposed to relying on a central authority, a blockchain is a decentralized database in which a transactional record of changes to the ledger is maintained and validated by each node of a peer-to-peer network. The distributed ledger is comprised of groupings of transactions organized together into a “block,” and ordered sequentially (thus the term “blockchain”). Nodes may join and leave the blockchain network over time and may obtain blocks that were propagated while the node was gone from peer nodes. Nodes may maintain addresses of other nodes and exchange addresses of known nodes with one another to facilitate the propagation of new information across the network in a decentralized, peer-to-peer manner.

The nodes that share the ledger form what is referred to herein as the distributed ledger network. The nodes in the distributed ledger network validate changes to the blockchain (e.g., when a new transaction and/or block is created) according to a set of consensus rules. The consensus rules depend on the information being tracked by the blockchain and may include rules regarding the chain itself. For example, a consensus rule may include that the originator of a change supply a proof-of-identity such that only approved entities may originate changes to the chain. A consensus rule may require that blocks and transactions adhere to format requirement and supply certain meta information regarding the change (e.g., blocks must be below a size limit, transactions must include a number of fields, etc.). Consensus rules may include a mechanism to determine the order in which new blocks are added to the chain (e.g., through a proof-of-work system, proof-of-stake, etc.).

Additions to the blockchain that satisfy the consensus rules are propagated from nodes that have validated the addition to other nodes that the validating node is aware of. If all the nodes that receive a change to the blockchain validate the new block, then the distributed ledger reflects the new change as stored on all nodes, and it may be said that distributed consensus has been reached with respect to the new block and the information contained therein. Any change that does not satisfy the consensus rule is disregarded by validating nodes that receive the change and is not propagated to other nodes. Accordingly, unlike a traditional system which uses a central authority, a single party cannot unilaterally alter the distributed ledger unless the single party can do so in a way that satisfies the consensus rules. The inability to modify past transactions leads to blockchains being generally described as trusted, secure, and immutable. Third party intermediaries who assist in the resolution of subrogation claims may thus be disintermediated from the process by a decentralized blockchain.

The validation activities of nodes applying consensus rules on a blockchain network may take various forms. In one implementation, the blockchain may be viewed as a shared spreadsheet that tracks data such as the ownership of assets. In another implementation, the validating nodes execute code contained in “smart contracts” and distributed consensus is expressed as the network nodes agreeing on the output of the executed code.

Blockchains may be deployed in a public, decentralized, and permissionless manner meaning that any party may view the distributed ledger, submit new information to be added to the ledger, or join the network as a validating node. Other blockchains are private that keep chain data private among a group of entities authorized to participate in the blockchain network. Yet other blockchains are permissioned which may be a hybrid of a public and a private blockchain. In some scenarios, private blockchains are maintained by a single entity, whereas permissioned blockchains include multiple authorized entities to make changes to the blockchain.

The present disclosure generally relates to, inter alia, using non-fungible tokens (NFTs) to track shipping items. Some embodiments disclosed herein advantageously track shipping items using NFTs on a blockchain. For example, an NFT may be minted representing ownership and/or possession of a shipping item. When a receiving party receives the shipping item, the NFT may be transferred to the receiving party to indicate that the receiving party possesses (e.g., has received) and/or now owns the shipping item.

Furthermore, the techniques described herein may provide a service to verify that the title holder of the physical item matches the NFT owner. For example, the service may use two-factor authentication for both the seller and buyer when a sale or transfer of the shipping container or cargo items is about to happen to ensure that the NFT reflects true ownership and to prevent fraud.

The systems and methods described herein have technical advantages over prior systems. For example, prior shipment tracking systems may rely on two separate databases (e.g., a database of the transferring party and a database of the receiving party); however, this presents a problem when there is a discrepancy between information in each database (e.g., one database indicates that the shipping item has been received, but the other database indicates that it has not yet been received). As will be seen, the systems and methods described herein provide an elegant solution to this by minting NFTs that are specific to one or more shipping items.

In another example, prior shipment tracking systems did not always accurately indicate who the true title holder of a shipping item was. By minting an NFT specifically in response to authentication of a true title holder, some embodiments advantageously, accurately, and reliably indicate the true title holder while tracking the shipping item. In this regard, this specific use of an NFT further makes the disclosed shipment tracking system more tamper resistant than prior systems.

Still other advantages will be further explained in the following disclosure.

### Exemplary System for Using NFTs to Track Shipping Items

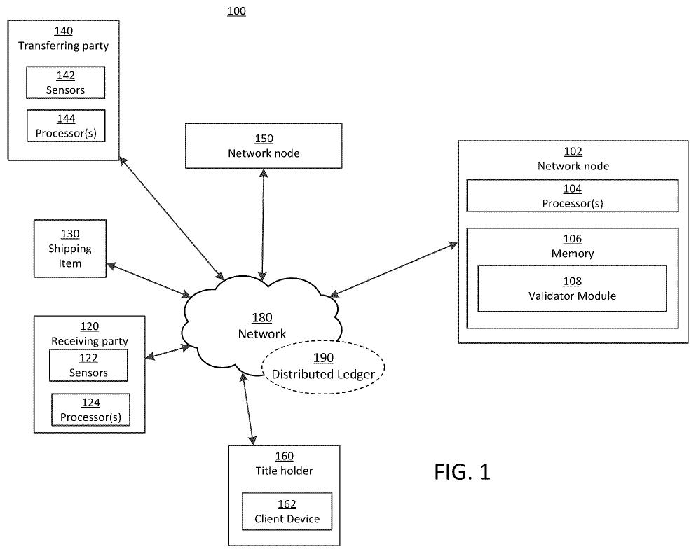

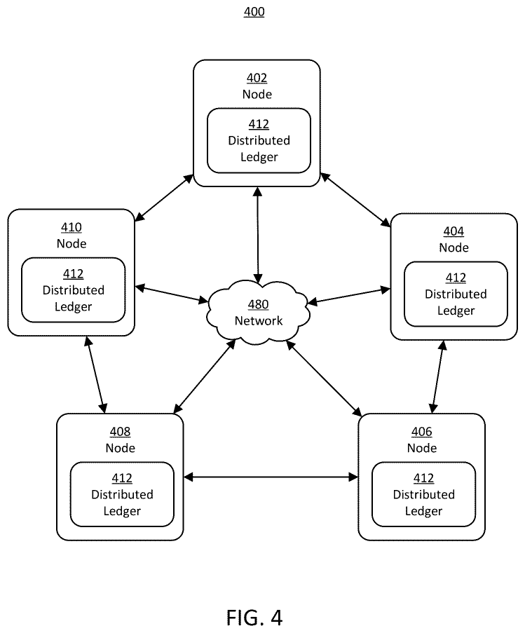

FIG. 1 shows an exemplary computer system 100 for using NFTs to track shipping items. The exemplary computer system 100 may include network nodes 102, 150, receiving party 120, shipping item 130, transferring party 140, and title holder 160, which may be communicatively connected through a network 180 as described below. According to certain embodiments, the network nodes 102, 150 may be a combination of hardware and software components, also as described in more detail below with reference to FIGS. 4-9. The network nodes 102, 150 may each include a memory 106, one or more processors 104, such as a microcontroller or a microprocessor, and other components not shown in FIG. 1 (e.g., a random-access memory (RAM), and/or an input/output (I/O) circuit), all of which may be interconnected via an address/data bus.

The memory 106 and/or RAM may store various applications for execution by the one or more processors 104. For example, a user interface application may provide a user interface to the network node 102, which user interface may, for example, allow the system administrator to configure, troubleshoot, and/or test various aspects of the node's operation.

The memory 106 may be tangible, non-transitory memory and may include any types of suitable memory modules, including RAM, read-only memory (ROM), flash memory, other types of persistent memory, etc. The memory 106 may store, for example, instructions executable on the processors 104 for a validator module 108.

The validator module 108 may validate changes to the blockchain (e.g., when a new transaction and/or block is created) according to a set of consensus rules. The consensus rules depend on the information being tracked by the blockchain and may include rules regarding the chain itself. For example, a consensus rule may include that the originator of a change supply a proof-of-identity such that only approved entities may originate changes to the chain. Consensus rules may include a mechanism to determine the order in which new blocks are added to the chain (e.g., through a proof-of-work system, proof-of-stake, etc.).

The validator module 108 may append distributed ledger data to the distributed ledger if the distributed ledger data satisfies the consensus rules by generating a new block of validated transactions to include in the distributed ledger 190 and/or by broadcasting a block of transactions to other network nodes. Otherwise, the validator module 108 may disregard any distributed ledger data that does not satisfy the consensus rules, and the distributed ledger data is not propagated to other network nodes. For example, the distributed ledger 190 may include NFTs that represent ownership and/or possession of the shipping item 130, and may be transferred to indicate ownership and/or possession of the shipping item 130.

In another implementation, network nodes 102, 150 on the distributed ledger 190 are configured to maintain a state database and execute code in smart contracts deployed by network participants. A smart contract on the distributed ledger 190 may expose methods and maintain the state of data relating to minting and/or transferring NFTs representing ownership and/or possession of shipping items 130.

The shipping item 130 may be any kind of shipping item 130. Examples of the shipping item 130 include a trailer, a shipping container, a cargo box, and/or a vehicle. In some embodiments, the shipping item may be labeled, such as with a barcode, a quick response (QR) code, a radio-frequency ID (RFID), etc. Furthermore, in some embodiments, the shipping item 130 may include an electronic device, which may include one or more processors, memory, wireless capabilities, etc. Thus, in some embodiments, the shipping item 130 may be connected to the network 180.

The receiving party 120 may be any entity that receives the shipping item 130. For example, the receiving party 120 may be a vehicle (e.g., a truck, car, trailer, etc.), a building (e.g., a warehouse, etc.), a person, etc. In some embodiments, the receiving party is the buyer of the shipping item 130.

The receiving party 120 may include sensor(s) 122. The sensors 122 may be any kind of sensor. Examples of the sensors 122 include: cameras (e.g., for capturing images and/or video), light detection and ranging (LIDAR) cameras, radio detection and ranging (RADAR) devices, accelerometers, gyroscopes, bar code readers, magnetometers, barometers, thermometers, proximity sensors, light sensors (e.g., light intensity detectors), electromagnetic radiation sensors (e.g., infrared and/or ultraviolet radiation sensors), ultrasonic and/or infrared range detectors, humistors, hygrometers, altimeters, microphones, audio or video recorders, weight scales, etc. In some examples, the sensor 122 is used in determining that the receiving party 120 has received the shipping item 130. Furthermore, although the example of FIG. 1 illustrates only one sensor 122, any number of sensors may be used.

Furthermore, in some embodiments, the receiving party 120 itself may be a network node on the distributed ledger 190. For example, the receiving party 120 may be a truck including one or more processors 124 which may be a network node on the distributed ledger 190.

The transferring party 140 may be any party that transfers the shipping item 130. For example, the transferring party 140 may be a vehicle (e.g., a truck, car, trailer, etc.), a person, etc. In some embodiments, the transferring party 140 is a seller of the shipping item 130.

The transferring party 140 may include sensor(s) 142. The sensors 142 may be any kind of sensor. Examples of the sensors 142 include: cameras (e.g., for capturing images and/or video), light detection and ranging (LIDAR) cameras, radio detection and ranging (RADAR) devices, accelerometers, gyroscopes, bar code readers, magnetometers, barometers, thermometers, proximity sensors, light sensors (e.g., light intensity detectors), electromagnetic radiation sensors (e.g., infrared and/or ultraviolet radiation sensors), ultrasonic and/or infrared range detectors, humistors, hygrometers, altimeters, microphones, audio or video recorders, weight scales, etc. In some examples, the sensor 142 is used in determining that the transferring party 140 has received the shipping item 130. Furthermore, although the example of FIG. 1 illustrates only one sensor 142, any number of sensors may be used.

Furthermore, in some embodiments, the transferring party 140 itself may be a network node on the distributed ledger 190. For example, the transferring party 140 may be a truck including one or more processors 144 which may be a network node on the distributed ledger 190.

Title holder 160 may be a title holder of the shipping item 130. The title holder 160 may have a client device 162, which may comprise, by way of example, a tablet computer, a cell phone, a personal digital assistant (PDA), a mobile device smart-phone also referred to herein as a “mobile device,” a laptop computer, a desktop computer, a portable media player, a wearable computing device, smart glasses, smart watches, phablets, other smart devices, devices configured for wired or wireless RF (Radio Frequency) or optical communication, etc. In some embodiments, a smart contract mints an NFT in response to the title holder 162 completing two-factor authentication using the client device 162; and the network node 102, 150 may then record the transaction.

In some embodiments, the titleholder 160 may be a buyer or seller of the shipping item 130.

The client device 162 may include a memory, one or more processors, such as a microcontroller or a microprocessor, and other components (e.g., a display, a communication unit, a user-input device, a RAM, and/or an I/O circuit) not shown in FIG. 1, all of which may be interconnected via an address/data bus. The memory may include an operating system, a data storage, a plurality of software applications, and/or a plurality of software routines. The data storage may include data such as user profiles, application data for a plurality of applications, routine data for the plurality of routines, and/or other data necessary to interact with the network nodes 102, 150 through the network 180. In some embodiments, the one or more processors may also include, or otherwise be communicatively connected to, other data storage mechanisms (e.g., one or more hard disk drives, optical storage drives, solid state storage devices, etc.) that reside within the client device 162. The communication unit may communicate with the network nodes 102, 150 via any suitable wireless communication protocol network, such as a wireless telephony network (e.g., GSM, CDMA, LTE, etc.), a Wi-Fi network (802.11 standards), a WiMAX network, a Bluetooth network, etc.

Furthermore, in some embodiments, the client device 162 itself may be a network node on the distributed ledger 190.

It will be appreciated that although only two network nodes 102, 150, one transferring party 140, one shipping item 130, one receiving party 120 and one title holder 160 are depicted in FIG. 1, any suitable number of network nodes 102, 150, any suitable number of transferring parties 140, any suitable number of shipping items 130, any suitable number of receiving parties 120, and any suitable number of title holders 160 may be included in the system.

The network nodes 102, 150, the transferring party 140, the shipping item 130, the receiving party 120, and/or the title holder 160 may communicate with each other via the network 180. The network 180 may be a proprietary network, a secure public Internet, a virtual private network and/or some other type of network, such as dedicated access lines, plain ordinary telephone lines, satellite links, a wireless telephony network, combinations of these, etc. Where the network 180 comprises the Internet, data communication may take place over the network 180 via an Internet communication protocol.

### Exemplary Tracking of Shipping Items

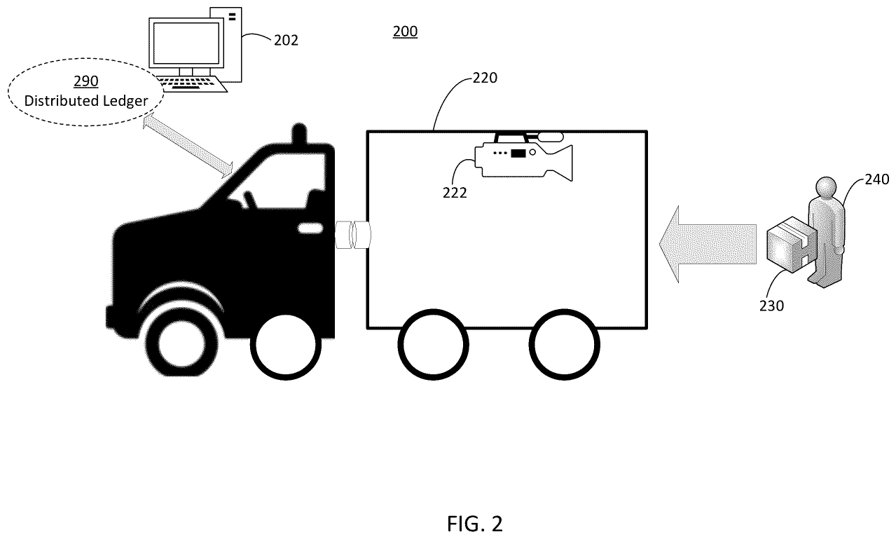

FIG. 2 illustrates an exemplary scenario 200 of tracking a shipping item using an NFT where the transferring party 240 is a person, and the receiving party 220 is a truck. In one implementation of the scenario 200, the transferring party 240 may carry the shipping item 230 into the receiving party 220. The camera 222 (or other sensor) of the receiving party 220 may detect that the transferring party 240 has delivered the shipping item 230 to the receiving party 240. Upon this detection, in some examples, the receiving party 220 may send imagery data (e.g., an image of receiving the shipping item 230) to a smart contract of the distributed ledger 290. In response, the smart contract may transfer the NFT to the receiving party 220 to indicate that the receiving party 220 possesses the shipping item 230. The network node 202 may then record the transaction on the distributed ledger 290.

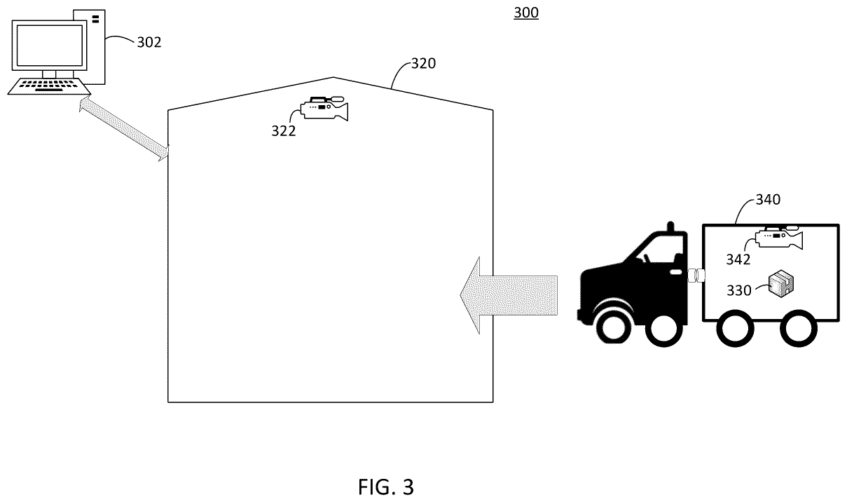

In another example, FIG. 3 shows an exemplary scenario 300 where the transferring party 340 comprises a truck, and the receiving party 320 comprises a warehouse. In one implementation of the scenario 300, the transferring party 340 delivers the shipping item 330 into the receiving party 320. The camera 342 (or other sensor) of the transferring party 340, and/or the camera 322 (or other sensor) of the receiving party 320 may detect that the transferring party 340 has delivered the shipping item 330 to the receiving party 320. Upon this detection, the receiving party 320 may send an indication to the network node 302 to transfer the NFT to the receiving party 320. In response to receiving the instruction, the network node 302 may transfer an NFT that represents ownership of the shipping item 330 to indicate that the receiving party 320 possesses the shipping item 330.

### Exemplary Distributed Ledgers for Tracking Shipping Items

FIG. 4 depicts an exemplary distributed ledger system 400 for tracking shipping items. The system 400 may include a distributed ledger 412 (e.g., having one or more distributed ledger layers) and a plurality of nodes 402, 404, 406, 408, and 410 (e.g., each similar to node 102 or 150 of FIG. 1). Each node maintains a copy of the distributed ledger 412. As changes are made to the distributed ledger 412, each node receives the change via the network 480 and updates its respective copy of the distributed ledger 412. A consensus mechanism may be used by the nodes 402-410 in the distributed ledger system 400 to decide whether it is appropriate to make received changes to the distributed ledger 412 or to a particular layer of the distributed ledger 412.

Each node in the system therefore has its own copy of the distributed ledger 412, which is identical to every other copy of the distributed ledger 412 stored by the other nodes. The distributed ledger system 400 may be more robust than a central authority database system because of the distributed ledger's decentralized nature. As such, there is no single point of failure on the distributed ledger system 400 as there would be in a centralized system.

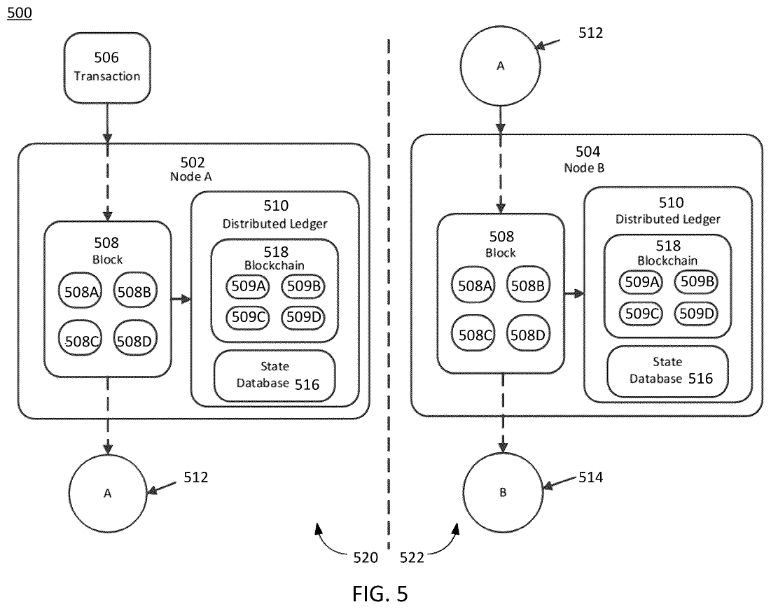

FIG. 5 depicts exemplary network nodes and an exemplary transaction flow 500 on a distributed ledger network for tracking shipping items. FIG. 5 includes two time frames 520 and 522 represented by the left and right sides of the dotted line, respectively, Node A 502 (e.g., node 102) and Node B 504 (e.g., node 150), a set of transactions 508A-508D, a set of blocks of transactions 509A-509D, a distributed ledger 510, and a blockchain 518.

The block propagation flow 500 may begin with Node A 502 receiving transaction 506 at time 520. When Node A 502 confirms that transaction 506 is valid, Node A 502 may add the transaction to a newly generated block 508. As part of adding the transaction 506 to block 508, Node A 502 may solve a cryptographic puzzle and include the solution in the newly generated block 508 as proof of the work done to generate the block 508. Alternatively, a proof of stake algorithm may be used to generate the block 508, whereby Node A 502 “stakes” an amount of a digital token used on the network, however, the network itself determines the node that will mint the new block. In another implementation, a proof of authority (PoA) algorithm may be used to generate the block 508, where transactions and blocks are validated by approved accounts, known as validators which run software allowing them to record transactions in the distributed ledger.

In other embodiments, the transaction 506 may be added to a pool of transactions until a sufficient number of transactions in the pool exist to form a block or distributed ledger entry. Node A 502 may transmit the newly created distributed ledger entry 508 to the network at time 512. Before or after propagating the distributed ledger entry 508, Node A 502 may add the distributed ledger entry 508 to its copy of the blockchain 518.

While proof of work, proof of stake, and proof of authority are described herein as consensus algorithms for selecting a node to mint a new block, these are merely a few example consensus algorithms and are not intended to be limiting. Additional consensus algorithms may be utilized, such as delegated proof of stake where nodes elect a subset of nodes referred to as delegates to perform validation, and the delegates take turns minting new blocks. Consensus algorithms may also include proof of weight, Byzantine fault tolerance, tangle consensus algorithms, block lattice consensus algorithms, etc. Additionally, quorum slices may be selected where a quorum is a set of nodes that participate in the consensus protocol and a quorum slice is its subset that helps a node in its agreement process. Individual trust decisions may be made by participants in the distributed ledger network to construct a quorum slice. Still further, security circles may be identified which are closed groups of network participants who together can form a quorum to reach a consensus on a transaction and to make further trust decisions.

In any event, the transactions 509A-509D may include updates to a state database 516. The state database 516 may contain current values of variables created by smart contracts deployed on the blockchain 518. Validated distributed ledger entries, such as distributed ledger entry 508, may include transactions effecting state variables in state database 516. At time 522, Node B 504 may receive the newly created distributed ledger entry 508 via the network at 512. Node B 504 may verify that the distributed ledger entry 508 is valid by checking the solution to the cryptographic puzzle provided in the distributed ledger entry 508. If the solution is accurate, then Node B 504 may add the distributed ledger entry 508 to its blockchain 518 and make any updates to the state database 516 as rejected by the transactions in distributed ledger entry 508. Node B 504 may then transmit the distributed ledger entry 508 to the rest of the network at time 514.

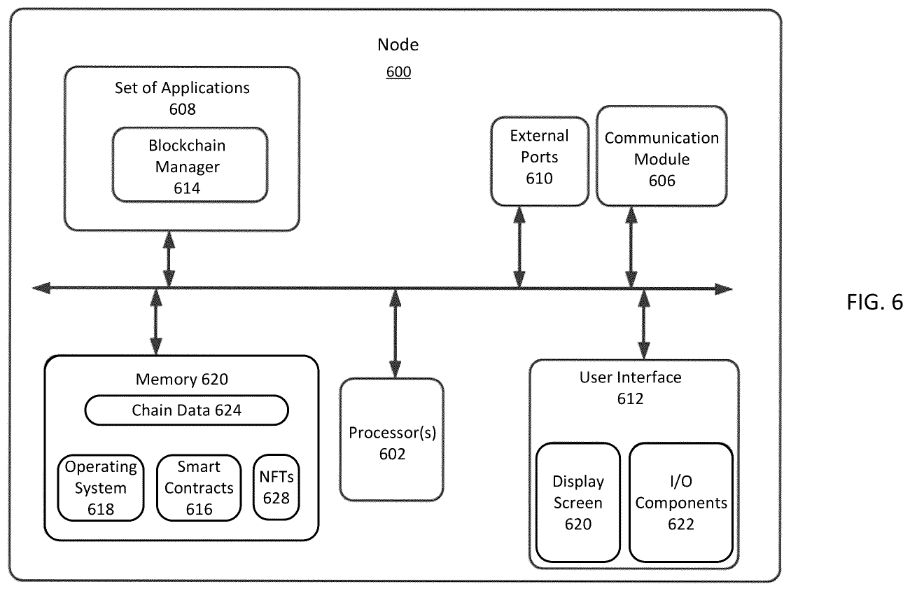

FIG. 6 depicts exemplary components of a network node 600 on a distributed ledger network for tracking shipping items. The network node 600 may be similar to the network nodes 102, 150 described above with reference to FIG. 1. Network node 600 may include at least one processor 602, memory 604, a communication module 606 such as a transceiver, a set of applications 608, external ports 610, a blockchain manager 614, smart contracts 616, NFTs 628, an operating system 618, user interface 612, display screen 620, and/or I/O components 622. In some embodiments, the network node 600 may generate a new block of transactions, or may broadcast transactions to other network nodes via the communication module 606 by using the blockchain manager 614. Similarly, the network node 600 may use the blockchain manager 614 in conjunction with the NFTs 628 and/or the smart contracts 616 stored in the memory 604 to provide the functionality disclosed herein. The memory 604 may further include chain data 624 including, for example, a state database of the blockchain for storing states of smart contracts deployed thereon.

In other embodiments, the smart contracts 616 operate independent of the blockchain manager 614 or other applications. In some embodiments, the network node 600 does not have a blockchain manager 614, NFTs 628, or smart contracts 616 stored at the network node. In some embodiments, the network node 600 may have additional or fewer components than described.

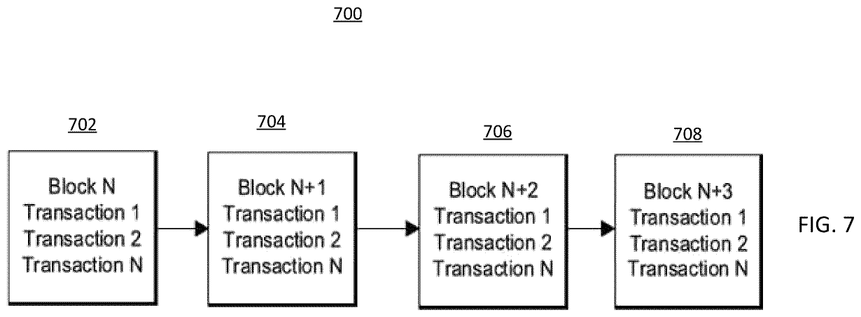

FIG. 7 depicts an exemplary distributed ledger 700 similar to the distributed ledger 190 as shown in FIG. 1. The example distributed ledger 700 includes a blockchain having blocks 702, 704, 706, 708 of transactions. In some embodiments, the blockchain 700 includes several blocks 702-708 connected together to form a chain of blocks 702-708 of transactions. To cryptographically link blocks and transactions together, each block in the blockchain 700 organizes its transactions into a Merkle Tree. In a Merkle Tree each transaction is hashed according to a cryptographic hashing algorithm (e.g., SHA-256) and the resulting output hash is then combined with the hash of another transaction. Then, the combined result may also be hashed according to the cryptographic hashing algorithm. This output is then combined with the hash of two other transactions and this process is repeated until all of the transactions in the block are combined and hashed to generate a Merkle root that is used in the header for a block 702-708. If any single transaction in the block is tampered with, a different Merkle root would be generated since the Merkle root is a combination of the hashes of all of the transactions in the block.

In other words, the transactions may be hashed using a cryptographic hash algorithm, such as the algorithms discussed above, and the hash of each transaction may be stored in the tree. As the tree is constructed the hash of each adjacent node at the same level may be hashed together to create a new node that exists at a higher level in the tree. Therefore, the node at the top of the tree or Merkle root, is dependent upon the hash of each transaction stored below in the tree. Each transaction may include a set of data. The set of data may include identifying data for the transaction, and transaction data identifying the nature of the transaction and what the transaction entails (e.g., input and output addresses, a transaction value, a document hash value, a timestamp, a transaction fee value, shipping item information, smart contract information, etc.).

To verify that a block is valid, a network node may compare the Merkle root of the block to the Merkle root for the same block included in other network nodes' copies of the blockchain. Thus, the Merkle root can be used as proof of the transactions included in the block and as proof that the contents of the block have not been tampered with if the Merkle root is the same in each network node's copy of the block.

In one implementation, documents stored “on” a blockchain are documents that have been hashed according to a cryptographic hashing algorithm (e.g., SHA-256) and the resulting output hash has been included in a transaction in a block that has been accepted by the network nodes as satisfying the consensus rules of the blockchain. As such, the documents may be later verified or validated by comparing the hash of the documents to the hash stored on the blockchain. For example, if a set of documents results in a SHA-256 hash that was recorded on a blockchain on a certain date, then the blockchain provides cryptographic proof that the documents existed as of that date.

One way of storing a document on a blockchain is to broadcast a transaction including a hash of the document to the network, which will be included in a block if the transaction satisfies all of the consensus rules of the network. In some implementations, the blockchain is a permissioned ledger, meaning only authorized network participants may broadcast transactions. In other implementations, only some authorized network participants may make certain transactions. Only a cryptographic hash of the data may be included in the blockchain 700, such that the data may be verified using the blockchain even if it is obtained by a party off-chain.

Network nodes may verify that the signed transaction or signed message was signed by the private cryptographic key corresponding to the published public cryptographic key owned by the user generating the transaction. In at least one implementation, a valid proof-of-identity may be applied as a consensus rule by the blockchain network. Each owner may be assigned a public key/private key pair which is identified in the blockchain network as corresponding to the owner. If the network nodes receive a transaction that is not from an authorized owner, the network nodes reject the transaction.

In some implementations, the blockchain 700 is a public blockchain meaning that any party may view the distributed ledger, submit new information to be added to the ledger, or join the network as a network node. The distributed ledger may also include side chains which are private or permissioned blockchains that keep chain data private among a group of entities authorized to participate in the side blockchain network. In other embodiments, the main blockchain 700 is also a permissioned blockchain but the main blockchain 700 has a larger number of entities authorized to participate in the blockchain network than the side chains.

In addition to protecting privacy via side chains, in some embodiments, privacy may be preserved on the main blockchain 700. For example, the transactions in the blockchain 700 may obfuscate the identities of the parties to the transaction and the transaction amounts through various encryption techniques.

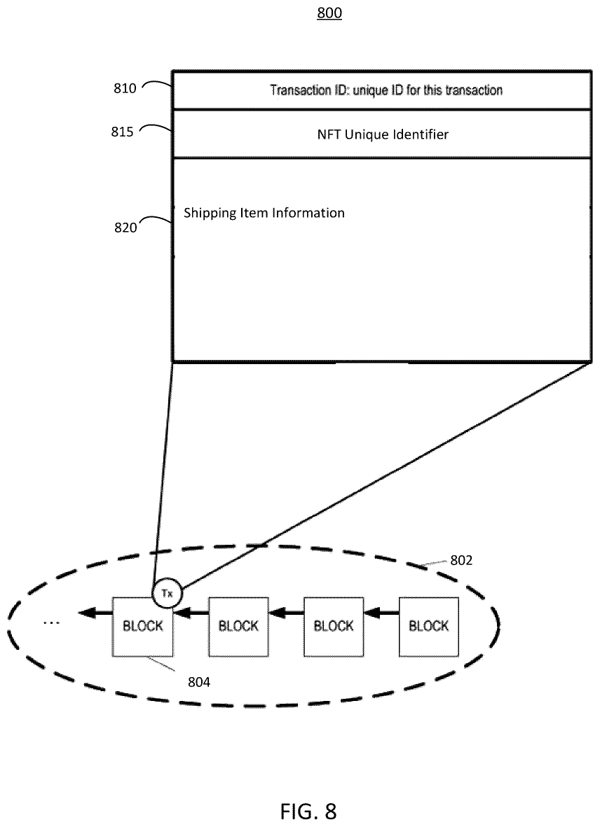

FIG. 8 depicts an exemplary transaction 800 on a distributed ledger network for minting an NFT in accordance with one aspect of the present disclosure. The transaction 800 may mint a new NFT to represent ownership of a shipping item. An originator of the transaction 800 may broadcast the transaction to nodes on the blockchain network and the transaction 800 will be included in block 804 if it is a valid transaction.

The transaction 800 may include various information 806. For example, the transaction 800 may include a transaction ID 810, an NFT unique identifier 815 such as a token identifier, a smart contract address for the NFT, and/or shipping item information 820 (e.g., a set of properties held by the NFT).

The shipping item information 820 may include any suitable information, such as identification information of the shipping item. The identification information of the shipping item may include a description of the shipping item (e.g., size, color, weight, etc.), bar code information, QR code information, description of the packaging of the shipping item, etc. Furthermore, in some embodiments, the NFT represents ownership and/or possession of more than one shipping item 130; and, in some of these embodiments, the shipping item information 820 may include information of more than one shipping item 130.

In some embodiments, the shipping item information 820 may be used to verify receipt of the shipping item. For example, a smart contract may receive an image of the shipping item 130 from the receiving party 120. If information from the received image maps correctly (e.g., within a predetermined tolerance) to information from the shipping item information 820 (e.g., item dimensions from the image and the shipping item information 820 match within a predetermined tolerance), the smart contract may transfer the NFT to the receiving party 120 to indicate that the receiving party 120 possesses the shipping item 130.

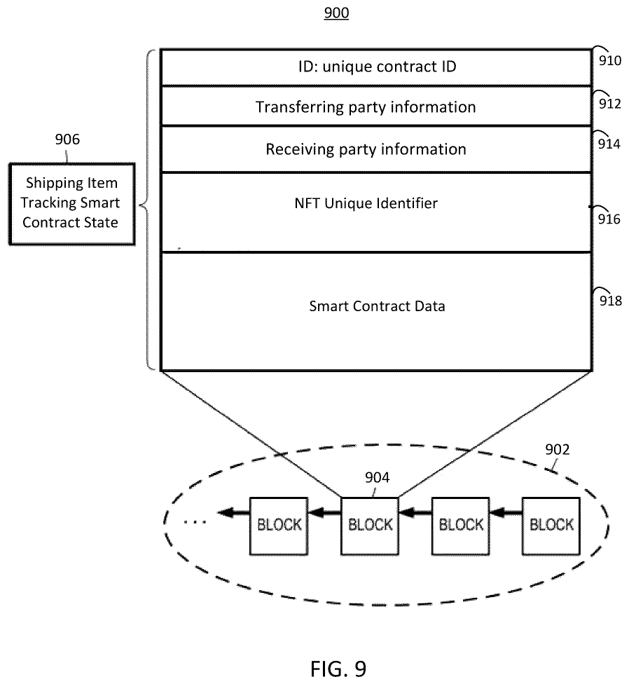

FIG. 9 depicts an exemplary smart contract state 900 in a distributed ledger network for tracking shipping items using NFTs.

One way of altering the shipping item tracking smart contract state 906 is to broadcast a transaction to the blockchain 902. If the broadcast transaction satisfies consensus rules, network nodes may include the transaction in a block 904. Inclusion in the blockchain 902 of a transaction sending data to the smart contract may cause network nodes to update a state database, thus allowing network participants access to a rich state mechanism to track shipping items.

In some implementations, the block of transactions 904 may organize the transactions it has received into a Merkle Tree to facilitate access to the stored transactions. The transactions may be hashed using a cryptographic hash algorithm, such as the algorithms discussed above, and the hash of each transaction may be stored in the tree. As the tree is constructed the hash of each adjacent node at the same level may be hashed together to create a new node that exists at a higher level in the tree. Therefore, the root of the tree, or the node at the top of the tree, is dependent upon the hash of each transaction stored below in the tree. Each transaction may include a set of data. The set of data may include identifying data for the transaction, and transaction data identifying the nature of the transaction and what the transaction entails (e.g., input and output addresses, a transaction value, a document hash value, a timestamp, a transaction fee value, etc.).

Shipping item tracking smart contract state 906 may include pieces of data to track the shipping item 130. For example, the shipping item smart contract state 906 may include a unique contract ID 910. The shipping item smart contract state 906 may further include transferring party information 912 (e.g., the name of the transferring party; if the transferring party is an individual, or a corporation; etc.). The shipping item smart contract state 906 may further include receiving party information 914 (e.g., the name of the receiving party; if the receiving party is an individual, or a corporation; etc.).

In at least one implementation, the transferring party 140 and the receiving party 120 are identified by cryptographic public keys assigned to the respective entities. Subsequent data sent to the smart contract may include a message signed by private keys corresponding to the public keys identifying the transferring party 140 and the receiving party 120 in the smart contract, thus providing cryptographic proof that the transaction was originated by one of the parties. The private and public keys may be managed solely by the parties to minimize the attack surface for any attackers that might attempt to forge a transaction (e.g., the parties generate public/private cryptographic key pairs offline and only provide the public key to other network participants). A party's private keys may be generated according to a securely stored seed value (e.g., on a piece of physical paper or multiple copies of a piece of paper) such that the private keys may be recovered in the case of a data loss.

The shipping item smart contract state 906 may further include the NFT unique identifier 916 (e.g., 815 of FIG. 8, etc.), such as a token ID associated with a particular smart contract for minting the NFT, where the particular smart contract has a smart contract address.

The shipping item smart contract state 906 may further include smart contract data 918, which may comprise any kind of data. For example, the smart contract data may include terms of a contract between the receiving party 120 and the transferring party 140 (e.g., price of the shipping item, payment terms of purchasing the shipping item, warranty information of the shipping item, delivery location information of the shipping item, a maximum amount of time to deliver the shipping item, etc.). In another example, the smart contract data 918 includes actions to be taken (e.g., possibly automatically executed by the smart contract) when conditions are met. For example, the smart contract may initiate a transfer of funds (e.g., in cryptocurrency and/or traditional currency) or a transfer of the NFT upon receipt of the indication that the receiving party has received the shipping item.

The smart contract data 918 may include any other kind of data as well. For example, the smart contract data 918 may include data indicating that the shipping item has been received by the receiving party 120. For example, the shipping item smart contract state 906 may include an indication received from either of the sensors 122, 142 that the shipping item has been received. In another example, the smart contract data 918 may include image data and/or video data received from either of the sensors 122, 142.

In another example, the smart contract data 918 includes the identification information of the shipping item.

Further regarding the discussion of both FIGS. 8 and 9, it should be noted that the distributed ledgers 802, 902 may transfer the NFTs by any suitable technique. For example, the transferring party 140 may submit a transaction (e.g., Tx of FIG. 8) to a network node to transfer the NFT; and a network node may then record the transaction.

In another example, the NFT may be held by a smart contract (e.g., the NFT is held in escrow by the smart contract for at least part of the shipping process). Either the transferring party 140 or the receiving party 120 may then submit data (e.g., an image of the shipping item 130 being received by the receiving party 120) to the smart contract. The smart contract may then review the submitted data (e.g., review the image using a machine learning algorithm) to determine if the NFT should be transferred to the receiving party 120. If so, the smart contract may transfer the NFT to the receiving party 120 to indicate possession and/or ownership of the shipping item 130. In this regard, the smart contract data 918 may include the conditions upon which the NFT may be transferred to the receiving party 120. For example, there may be a condition that an image must be uploaded to the smart contract which shows the shipping item 130 being received by the receiving party 120. The smart contract data 918 may further include a machine learning algorithm to analyze the uploaded data (e.g., the uploaded image) to determine if the shipping item 130 has been received.

### Exemplary Methods for Using NFTs to Track Shipping Items

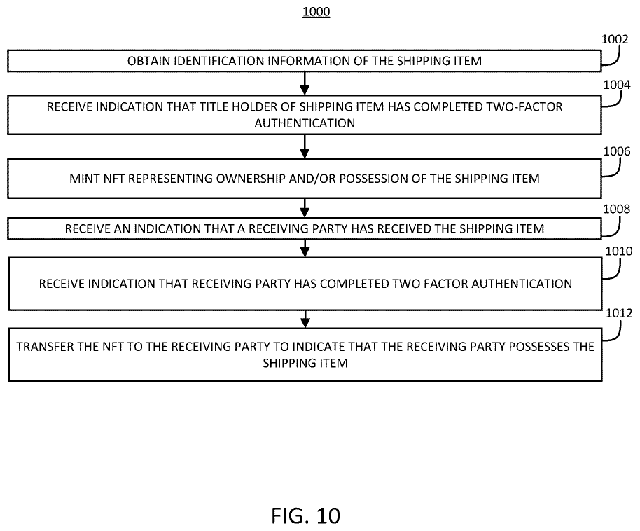

FIG. 10 shows an exemplary implementation or computer-implemented method 1000 of tracking shipping items using NFTs. The exemplary implementation 1000 begins at block 1002 when identification information of the shipping item is obtained (e.g., by a smart contract).

The identification information may comprise any information suitable to identify the shipping item. Examples of the identification information include: a name of the shipping item, a description of the shipping item (e.g., size, weight, color, texture, etc.), a description of packaging of the shipping item, barcode information, QR code information, RFID information, etc. If the shipping item is a vehicle, further examples include: vehicle identification number (VIN), year of the vehicle, make of the vehicle, model of the vehicle, license plate number of the vehicle, etc.

At block 1004, an indication that the title holder 160 of the shipping item has completed two-factor authentication is received (e.g., by the network node 102, 150, etc.). Advantageously, the title holder 160 completing the two-factor authentication provides an additional guarantee that the true title holder 160 is involved in the transaction, and no forgery has occurred.

The two-factor authentication may be completed by any suitable technique. For example, the two-factor authentication may be based upon: (i) password or passcode, and (ii) biometric data (e.g., fingerprint data, facial recognition data, etc.). Additionally or alternatively, the two-factor authentication may be based upon an authentication code sent to the title holder. The authentication code may be sent to the title holder 160 via any suitable technique, such as by text message, email, voice call, etc. The title holder 160 may then send the received authentication code (e.g., to either of the nodes 102, 150, or to any other authenticating component, etc.) to complete the two-factor authentication.

At block 1006, an NFT may be minted (e.g., by a smart contract), and may include the identification information of the shipping item 130. The NFT may represent ownership of the shipping item 130. Additionally or alternatively, the NFT may represent possession of the shipping item 130. In this regard, a party owning the shipping item 130 may be the same or different than a party possessing the shipping item 130. In one example where the owning and possessing parties are different, the titleholder 160 may own the shipping item 130, but, during shipment of the shipping item 130, either the transferring party 140 or the receiving party 120 possesses the shipping item.

In some embodiments, the minting of the NFT occurs in response to receiving the indication that the titleholder 160 has completed the two-factor authentication. In one example, the shipping item 130 is a vehicle, and the titleholder 160 is the titleholder of the vehicle. The titleholder 160 may desire to ship the vehicle via the transferring party 140. In this example, when the titleholder 160 leaves the vehicle with the transferring party 140 for shipment, the titleholder 160 may complete a two-factor authentication process to trigger minting of the NFT. Further in this example, when the NFT is minted, the NFT may represent that: (i) the title holder 160 owns the vehicle, and/or (ii) the transferring party 140 possesses the vehicle.

Furthermore, upon minting of the NFT, an additional smart contract may be created or modified. For example, an additional smart contract may be created which includes a condition that the NFT will be transferred to the receiving party 120 when the receiving party 120 receives the shipping item. Additionally or alternatively, the additional smart contract may include a condition that payment (e.g., in cryptocurrency and/or traditional currency) will be sent upon the receiving party 120 receiving the shipping item 130 (e.g., payment from the transferring party 140 to the receiving party 120, or vice versa).

In addition, in some embodiments, the minted NFT represents more than one shipping item 130. For example, the smart contract may obtain identification information of multiple shipping items 130 (e.g., block 1002 may be repeated) until identification information for a predetermined number shipping items is obtained. The NFT may then be minted to represent ownership and/or possession of the shipping items 130 for which identification information was obtained. The minted NFT may include each of the obtained identification information. Advantageously, this grouping of a predetermined number of shipping items into a single NFT reduces the necessary amount of processing power, and thus reduces the carbon footprint.

At block 1008, an indication that the receiving party 120 has received the shipping item 130 is received (e.g., by the smart contract or network node 102, 150, etc.). In one example, a worker (e.g., of the receiving party 120) may press a button on her smartphone that commands the smartphone to send a signal (e.g., to the smart contract or network node 102, 150, etc.) indicating that the shipping item 130 has been received.

In another example, either of the one or more processors 124, 142 may analyze sensor data (e.g., generated by the sensors 122 and/or sensors 142, e.g., a video feed generated by the sensors 122 and/or sensors 142, data from a weight sensor, a barcode scanner, etc.) to determine that the shipping item 130 has been received; and, upon completing this determination, the transferring party 140 and/or the receiving party 120 may send the indication that the shipping item 130 has been received to the smart contract or network node 102, 150. The determination may be made by any suitable technique. For example, the determination may be made by analyzing the sensor data (e.g., generated by the sensors 122 and/or sensors 142) with a machine learning algorithm. For instance, the sensor data may be input into a trained machine learning algorithm to determine if the shipping item 130 has been received by the receiving party 120. Furthermore, the machine learning algorithm may have been trained by any suitable technique (e.g., supervised learning, unsupervised learning, semi-supervised learning). Examples of the machine learning algorithm may include neural networks, deep learning algorithms, etc. Examples of the sensor data include any kind of data generated by one or both of the sensors 122, 142. For instance, the sensor data may include imagery data (e.g., image data, video data, LIDAR data, etc.), weight data, etc.

In one example that does not use a machine learning algorithm, the sensors 122 may comprise a weight scale. When the weight scale 122 indicates a weight above a threshold, the receiving party 120 sends the indication that the shipping item has been received to a network node 102, 150.

In some examples (e.g., where the one or more processors 124, and/or 142 have analyzed sensor data), the indication received at block 1008 comprises an instruction to transfer the NFT. For example, the transferring party 140 may send an instruction to a network node to transfer the NFT, and the network node may record a transaction transferring the NFT.

However, in other examples, sensor data may be sent to the smart contract or network node 102, 150; and, the smart contract or network node 102, 150 may analyze the received sensor data to determine if the shipping item 130 has been received. In response to a determination that the shipping item has been received, the smart contract or network node may generate the indication that the shipping item has been received. In one example, the sensor data may be input (e.g., by the network node 102, 150) into a trained machine learning algorithm to determine if the shipping item 130 has been received by the receiving party 120. Furthermore, the machine learning algorithm may have been trained by any suitable technique (e.g., supervised learning, unsupervised learning, semi-supervised learning). Examples of the machine learning algorithm may include neural networks, deep learning algorithms, etc.

In still other examples, the shipping item 130 may send the indication that it has been received by the receiving party 120. For example, the shipping item 130 may contain an RFID tag that indicates to a processor(s) of the shipping item 130 when it is in a particular area that qualifies it has having been received by the receiving party 120. When the RFID indicates that it is in the particular area, the processor(s) of the shipping item 130 may send the indication that the shipping item 130 has been received to the smart contract or network node 102, 150.

Some examples use identification information of the shipping item 130 as part of generating the indication that the receiving party 120 has received the shipping item 130. Examples of the identification information include a bar code, a QR code, an RFID tag, etc. In some examples, the receiving party 120 scans the barcode (or other identifying information) of the shipping item 130, and, in response, the indication that the shipping item has been received by the receiving party 120 is automatically sent to the smart contract or network node 102, 150.

At block 1010, an indication is received (e.g., by the smart contract or network node 102, 150) that the receiving party 120 has completed two-factor authentication. The two-factor authentication may be completed by any suitable technique. For example, the two-factor authentication may be based upon: (i) password or passcode, and (ii) biometric data (e.g., fingerprint data, facial recognition data, etc.). Additionally or alternatively, the two-factor authentication may be based upon an authentication code sent to the title holder. The authentication code may be sent to the title holder 160 via any suitable technique, such as by text message, email, voice call, etc. The title holder 160 may then send the received authentication code (e.g., to either of the network nodes 102, 150, or to any other authenticating component, etc.) to complete the two-factor authentication.

Advantageously, this two-factor authentication may be used as confirmation that the receiving party 120 has received the shipping item 130. For example, this advantageously reduces the possibility that the receiving party 120 is being fraudulently impersonated.

At block 1012, the NFT is transferred (e.g., by the smart contract or network node 102, 150) to the receiving party 120 to indicate that the receiving party 120 possesses the shipping item 130. In some embodiments, the transfer is done in response to the receipt of the indication that the receiving party 120 has received the shipping item 130.

In some embodiments, a smart contract may transfer the NFT only when both (i) the indication that the receiving party 120 has received the shipping item 130 has been received, and (ii) the indication that the receiving party 120 has completed the two-factor authentication has been received.

In some embodiments, the smart contract may initiate a transfer that simultaneously indicates that the receiving party 120 both possesses and owns the shipping item 130. For example, the smart contract may initiate this transfer when the smart contract has received some or all of the following: (i) the indication that the titleholder 160 has completed two-factor authentication (block 1004), (ii) the indication that the receiving party 120 has received the shipping item 130 (block 1008), and/or (iii) the indication that the receiving party 120 has completed two-factor authentication (block 1010). Advantageously, this combines, and thus streamlines, the processes for tracking ownership and possession of a shipping item.

In another example, the transferring party also completes a two-factor authentication process (e.g., such as the two-factor authentication processes described above). In such embodiments, in some examples, the smart contract may transfer the NFT to indicate that the receiving party possesses the shipping item 130 upon receiving: (i) an indication that the receiving party 120 has completed the authentication process, and/or (ii) an indication that the transferring party 140 has completed the authentication process.

Furthermore, in some embodiments, the transfer is made on the distributed ledger as part of a block of transactions. For example, the smart contract may gather indications that shipping items 130 have been received (e.g., by repeating block 1002). Upon gathering a predetermined number of indications that shipping items 130 have been received, the smart contract may add them as a block of transactions to the distributed ledger 190. Advantageously, this grouping of transactions together reduces the necessary amount of processing, and thus reduces the carbon footprint.

It should further be noted that the method 1000 may include additional, less, or alternate actions, including those discussed elsewhere herein.

### Applicability to the Insurance Industry

Some embodiments have particular applicability to the insurance industry. For example, shipping companies may receive discounts to insurance premiums if they opt into programs in accordance with the techniques described herein. For instance, if receiving party 120 is a shipping company, the shipping company may receive a discount on an insurance premium by agreeing to track shipping items 130 in accordance with any of the techniques described herein.

### Exemplary Use of NFTs to Track Shipping Items

In one aspect, a computer-implemented method for using non-fungible tokens (NFTs) to track shipping items may be provided. The method may be implemented via one or more local or remote processors, servers, sensors, transceivers, virtual reality headsets, memory units, and/or other electronic or electrical components. In one instance, the method may include: (1) obtaining, via one or more processors, identification information of a shipping item; (2) minting, via the one or more processors, an NFT on a distributed ledger, the NFT representing ownership of the shipping item and including the identification information of the shipping item; (3) receiving, via the one or more processors, an indication that a receiving party has received the shipping item; and/or (4) in response to receiving the indication that the receiving party has received the shipping item, transferring, via the one or more processors, the NFT to the receiving party to indicate that the receiving party possesses the shipping item. The method may include additional, fewer, or alternate actions, including those discussed elsewhere herein.

For instance, the shipping item may be a trailer, a shipping container, and/or a cargo box. In some embodiments, the method may further include: receiving, via the one or more processors, an indication that a title holder of the shipping item has completed a two-factor authentication process; and/or wherein minting of the NFT occurs in response to receiving the indication that the title holder of the shipping item has completed the two-factor authentication process.

In some embodiments, the NFT may be transferred to the receiving party via a smart contract to indicate that the receiving party possesses the shipping item. Additionally or alternatively, the method may further include receiving, via the one or more processors, an indication that the receiving party has completed a two-factor authentication process; and/or wherein the setting the indication in the NFT to indicate that the receiving party possesses the shipping item occurs further in response to the receiving of the indication that the receiving party has completed the two-factor authentication process.

The method may further include (i) receiving, via the one or more processors, data from a weight sensor or barcode scanner; and/or (ii) generating, via the one or more processors, the indication that the receiving party has received the shipping item based upon the data received from the weight sensor or barcode scanner.

In some embodiments, the method may further include receiving, via the one or more processors, data from a weight sensor or barcode scanner; and/or a smart contract may generate the indication that the receiving party has received the shipping item based upon the data received from the weight sensor or barcode scanner.

In some embodiments, the receiving the indication may include (i) receiving, via the one or more processors, a video feed; and/or (ii) analyzing, via the one or more processors, the video feed to determine that the receiving party has received the shipping item. In certain embodiments, the receiving the indication may include (i) receiving, via the one or more processors, a video feed; and/or (ii) determining, via the one or more processors, that the receiving party has received the shipping item by inputting the video feed into a trained machine learning algorithm.

In another aspect, a computer system for using non-fungible tokens (NFTs) to track shipping items may be provided. The computer system may comprise one or more local or remote processors, transceivers, servers, and/or sensors configured to: (1) obtain identification information of a shipping item; (2) mint an NFT on a distributed ledger, the NFT representing ownership of the shipping item and including the identification information of the shipping item; (3) receive an indication that a receiving party has received the shipping item; and/or (4) in response to receiving the indication that the receiving party has received the shipping item, transfer, via the one or more processors, the NFT to the receiving party to indicate that the receiving party possesses the shipping item. The computer system may include additional, less, or alternate functionality, including that discussed elsewhere herein.

For instance, the shipping item may be a trailer, a shipping container, and/or a cargo box.

In some embodiments, the one or more local or remote processors, transceivers, and/or sensors may be further configured to: receive an indication that a title holder of the shipping item has completed a two-factor authentication process; and/or mint the NFT in response to receiving the indication that the title holder of the shipping item has completed the two-factor authentication process. Additionally or alternatively, the one or more local or remote processors, transceivers, and/or sensors may be further configured to execute a smart contract to cause transferring the NFT to the receiving party to indicate that the receiving party possesses the shipping item.

In certain embodiments, the one or more local or remote processors, transceivers, and/or sensors may be further configured to (i) receive data from a weight sensor or barcode scanner; and/or (ii) generate the indication that the receiving party has received the shipping item based upon the data received from the weight sensor or barcode scanner.

In some embodiments, the one or more local or remote processors, transceivers, and/or sensors may be further configured to (i) receive data from a weight sensor or barcode scanner; and/or (ii) use a smart contract to generate the indication that the receiving party has received the shipping item based upon the data received from the weight sensor or barcode scanner.

In yet another aspect, a computer device for using non-fungible tokens (NFTs) to track shipping items may be provided. The computer device may comprise: one or more processors and transceivers; and one or more memories coupled to the one or more processors. The one or more memories including computer executable instructions stored therein that, when executed by the one or more processors, may cause the one or more processors to: (1) obtain identification information of a shipping item; (2) mint an NFT on a distributed ledger, the NFT representing ownership of the shipping item and including the identification information of the shipping item; (3) receive an indication that a receiving party has received the shipping item; and/or (4) in response to receiving the indication that the receiving party has received the shipping item, transfer, via the one or more processors, the NFT to the receiving party to indicate that the receiving party possesses the shipping item. The computer device may include additional, less, or alternate functionality, including that discussed elsewhere herein.

For instance, the shipping item may be a trailer, a shipping container, and/or a cargo box.

In some embodiments, the one or more memories including computer executable instructions stored therein that, when executed by the one or more processors, may further cause the one or more processors to (i) receive an indication that a title holder of the shipping item has completed a two-factor authentication process; and/or (ii) mint the NFT in response to receiving the indication that the title holder of the shipping item has completed the two-factor authentication process.

In certain embodiments, the one or more memories including computer executable instructions stored therein that, when executed by the one or more processors, may further cause the one or more processors to execute a smart contract to cause transferring the NFT to the receiving party to indicate that the receiving party possesses the shipping item.

Additionally or alternatively, the one or more memories including computer executable instructions stored therein that, when executed by the one or more processors, may further cause the one or more processors to (i) receive data from a weight sensor or barcode scanner; and/or (ii) generate the indication that the receiving party has received the shipping item based upon the data received from the weight sensor or barcode scanner.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules.

In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for using non-fungible tokens (NFTs) to track shipping items, the method comprising:
obtaining, via one or more processors, identification information of a shipping item;
minting, via the one or more processors, an NFT on a distributed ledger, the NFT representing ownership of the shipping item and including the identification information of the shipping item;
receiving, via the one or more processors, an indication that a receiving party has received the shipping item; and
in response to receiving the indication that the receiving party has received the shipping item, transferring, via the one or more processors, the NFT to the receiving party to indicate that the receiving party possesses the shipping item.

2. The computer-implemented method of claim 1, wherein the shipping item is a trailer, a shipping container, and/or a cargo box.

3. The computer-implemented method of claim 1, further comprising receiving, via the one or more processors, an indication that a title holder of the shipping item has completed a two-factor authentication process; and
wherein minting of the NFT occurs in response to receiving the indication that the title holder of the shipping item has completed the two-factor authentication process.

4. The computer-implemented method of claim 1, wherein the NFT is transferred to the receiving party via a smart contract to indicate that the receiving party possesses the shipping item.

5. The computer-implemented method of claim 1, further comprising receiving, via the one or more processors, an indication that the receiving party has completed a two-factor authentication process; and
wherein the setting the indication in the NFT to indicate that the receiving party possesses the shipping item occurs further in response to the receiving of the indication that the receiving party has completed the two-factor authentication process.

6. The computer-implemented method of claim 1, further comprising:
receiving, via the one or more processors, data from a weight sensor or barcode scanner; and
generating, via the one or more processors, the indication that the receiving party has received the shipping item based upon the data received from the weight sensor or barcode scanner.

7. The computer-implemented method of claim 1, further comprising:
receiving, via the one or more processors, data from a weight sensor or barcode scanner; and
wherein a smart contract generates the indication that the receiving party has received the shipping item based upon the data received from the weight sensor or barcode scanner.

8. The computer-implemented method of claim 1, wherein the receiving the indication comprises:
receiving, via the one or more processors, a video feed; and
analyzing, via the one or more processors, the video feed to determine that the receiving party has received the shipping item.

9. The computer-implemented method of claim 1, wherein the receiving the indication comprises:
receiving, via the one or more processors, a video feed; and
determining, via the one or more processors, that the receiving party has received the shipping item by inputting the video feed into a trained machine learning algorithm.

10. A computer system for using non-fungible tokens (NFTs) to track shipping items, the computer system comprising one or more local or remote processors, transceivers, and/or sensors configured to:
obtain identification information of a shipping item;
mint an NFT on a distributed ledger, the NFT representing ownership of the shipping item and including the identification information of the shipping item;
receive an indication that a receiving party has received the shipping item; and
in response to receiving the indication that the receiving party has received the shipping item, transfer, via the one or more processors, the NFT to the receiving party to indicate that the receiving party possesses the shipping item.

11. The computer system of claim 10, wherein the shipping item is a trailer, a shipping container, and/or a cargo box.

12. The computer system of claim 10, wherein the one or more local or remote processors, transceivers, and/or sensors are further configured to:
receive an indication that a title holder of the shipping item has completed a two-factor authentication process; and
mint the NFT in response to receiving the indication that the title holder of the shipping item has completed the two-factor authentication process.

13. The computer system of claim 10, wherein the one or more local or remote processors, transceivers, and/or sensors are further configured to execute a smart contract to cause transferring the NFT to the receiving party to indicate that the receiving party possesses the shipping item.

14. The computer system of claim 10, wherein the one or more local or remote processors, transceivers, and/or sensors are further configured to:
receive data from a weight sensor or barcode scanner; and
generate the indication that the receiving party has received the shipping item based upon the data received from the weight sensor or barcode scanner.

15. The computer system of claim 10, wherein the one or more local or remote processors, transceivers, and/or sensors are further configured to:
receive data from a weight sensor or barcode scanner; and
use a smart contract to generate the indication that the receiving party has received the shipping item based upon the data received from the weight sensor or barcode scanner.

16. A computer device for using non-fungible tokens (NFTs) to track shipping items, the computer device comprising:
one or more processors; and
one or more memories coupled to the one or more processors;
the one or more memories including computer executable instructions stored therein that, when executed by the one or more processors, cause the one or more processors to:
obtain identification information of a shipping item;
mint an NFT on a distributed ledger, the NFT representing ownership of the shipping item and including the identification information of the shipping item;
receive an indication that a receiving party has received the shipping item; and
in response to receiving the indication that the receiving party has received the shipping item, transfer, via the one or more processors, the NFT to the receiving party to indicate that the receiving party possesses the shipping item.

17. The computer device of claim 16, wherein the shipping item is a trailer, a shipping container, and/or a cargo box.

18. The computer device of claim 16, wherein the one or more memories including computer executable instructions stored therein that, when executed by the one or more processors, further cause the one or more processors to:
receive an indication that a title holder of the shipping item has completed a two-factor authentication process; and
mint the NFT in response to receiving the indication that the title holder of the shipping item has completed the two-factor authentication process.

19. The computer device of claim 16, wherein the one or more memories including computer executable instructions stored therein that, when executed by the one or more processors, further cause the one or more processors to execute a smart contract to cause transferring the NFT to the receiving party to indicate that the receiving party possesses the shipping item.

20. The computer device of claim 16, wherein the one or more memories including computer executable instructions stored therein that, when executed by the one or more processors, further cause the one or more processors to:
receive data from a weight sensor or barcode scanner; and
generate the indication that the receiving party has received the shipping item based upon the data received from the weight sensor or barcode scanner.
